(19) United States
(12) Patent Application Publication
(10) Pub. No.: US 2009/0051868 A1
(43) Pub. Date: Feb. 26, 2009

(54) SPECTACLE FRAME

(75) Inventor: Po Kwong KWAN, Hong Kong (CN)

Correspondence Address: WILLIAM J. SAPONE;COLEMAN SUDOL SAPONE P.C., 714 COLORADO AVENUE, BRIDGE PORT, CT, 06605, US

(73) Assignee: FAITH IDEA LIMITED, Kowloon (HK)

(21) Appl. No.: 11/844,380

(22) Filed: Aug. 24, 2007

(51) Int. Cl. G02C 5/12

(52) U.S. Cl. 351/137

(57) ABSTRACT

A spectacle frame is disclosed as including a pair of mounting frames each for releasably holding a piece of optical lens, and a nose pad engaged with each respective mounting frame, in which the nose pad is swivellable about the respective mounting frame about a respective axis which lies generally on a plane containing the respective mounting frame. There is also disclosed a pair of spectacles including such a spectacle frame.

This invention relates to a spectacle frame, and a pair of spectacles including such a spectacle frame.

### BACKGROUND OF THE INVENTION

There are spectacle frames of various construction to which optical lenses may be mounted for forming spectacles for wearing. In order to minimize the space occupied by a pair of spectacles, e.g. for storage, there are in existence spectacle frames in which the bridge and two arms may be folded. Although such spectacle frames may be folded, it is found that the pads which are, in use, in abutment with the nose of a user prevent the spectacle frames from being folded compactly.

In addition, when a user wears a pair of spectacles by placing the spectacles onto his/her nose, it is usually necessary for the user to adjust the position of the nose pads (and thus of the spectacles) to achieve comfort in wearing.

It is thus an object of the present invention to provide a spectacle frame and a pair of spectacles in which the aforesaid shortcomings are mitigated, or at least to provide a useful alternative to the trade and public.

### SUMMARY OF THE INVENTION

According to a first aspect of the present invention, there is provided a spectacle frame including a pair of frame members each adapted to releasably hold a piece of optical lens, and a nose pad engaged with each respective frame member, wherein said nose pad is swivellable about said respective frame member about a respective axis which lies generally on a plane containing said respective frame member.

According to a first aspect of the present invention, there is provided a pair of spectacles including a spectacle frame, said spectacle frame including a pair of frame members each releasably holding a piece of optical lens, and a nose pad engaged with each respective frame member, wherein said nose pad is swivellable about said respective frame member about a respective axis which lies generally on a plane containing said respective frame member.

### BRIEF DESCRIPTION OF THE DRAWINGS

Preferred embodiments of the present invention will now be described, by way of examples only, with reference to the accompanying drawings, in which:

FIG. 1 is a front perspective view of a pair of spectacles according to a first preferred embodiment of the present invention;

FIG. 2 is a rear perspective view of the pair of spectacles shown in FIG. 1;

FIG. 3 is a further rear perspective view of the pair of spectacles shown in FIG. 2, showing folding of the pair of arms;

FIG. 4A is a yet further rear perspective view of the pair of spectacles shown in FIG. 2, showing further folding of the pair of arms;

FIG. 4B is a partial enlarged view of the pair of spectacles shown in FIG. 4A, showing the connection between the nose pad and the spectacle frame;

FIG. 4C is a further partial enlarged view of the pair of spectacles shown in FIG. 4A, showing movement of the nose pad;

FIG. 5 is a perspective view showing folding up of the pair of spectacles shown in FIG. 4A;

FIG. 6 is a bottom view of the pair of spectacles shown in FIG. 5;

FIG. 7A is a front perspective view of a pair of spectacles according to a second preferred embodiment of the present invention;

FIG. 7B is a partial enlarged view of the pair of spectacles shown in FIG. 7A, showing the connection between the nose pad and the spectacle frame; and

FIG. 7C is a further partial enlarged view of the pair of spectacles shown in FIG. 7A, showing movement of the nose pad.

### DETAILED DESCRIPTION OF THE PREFERRED EMBODIMENTS

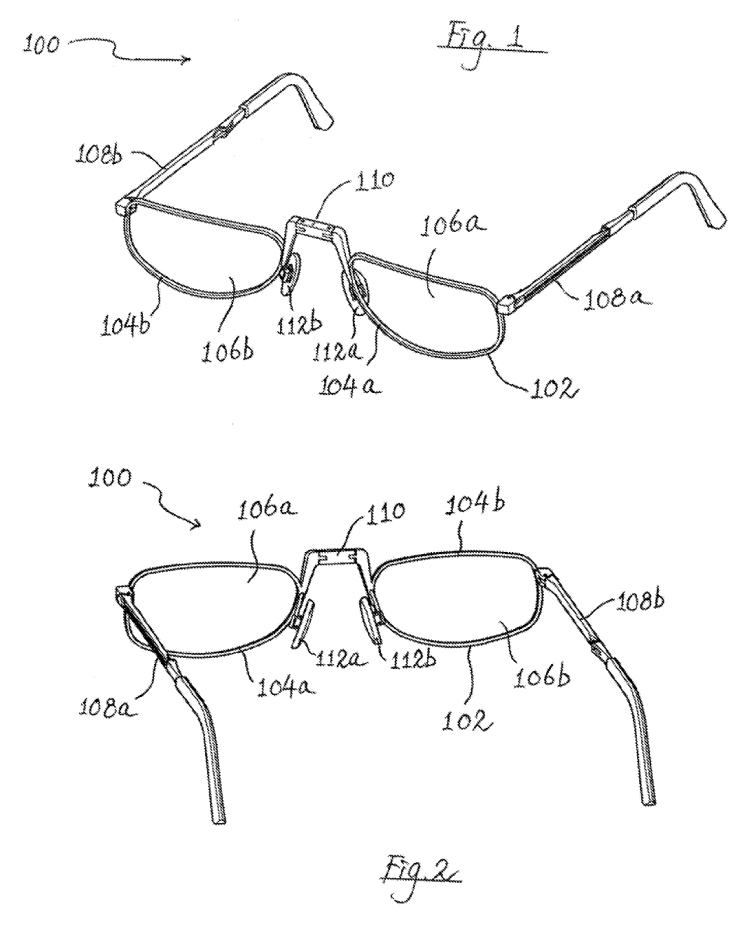

FIGS. 1 and 2 show a pair of spectacles according to a first preferred embodiment of the present invention, generally designated as 100. The pair of spectacles 100 includes a spectacle frame 102 with two mounting frames 104a, 104b to each of which a respective piece of optical lens 106a, 106b is releasably mounted. To the outer side of each mounting frame 104a, 104b is an arm 108a, 108b which is pivotable relative to the respective mounting frame 104a, 104b. The two mounting frames 104a, 104b are connected with each other via a bridge 110. To the inner side of each mounting frame 104a, 104b is engaged a nose pad 112a, 112b, the structure of which will be further discussed herebelow.

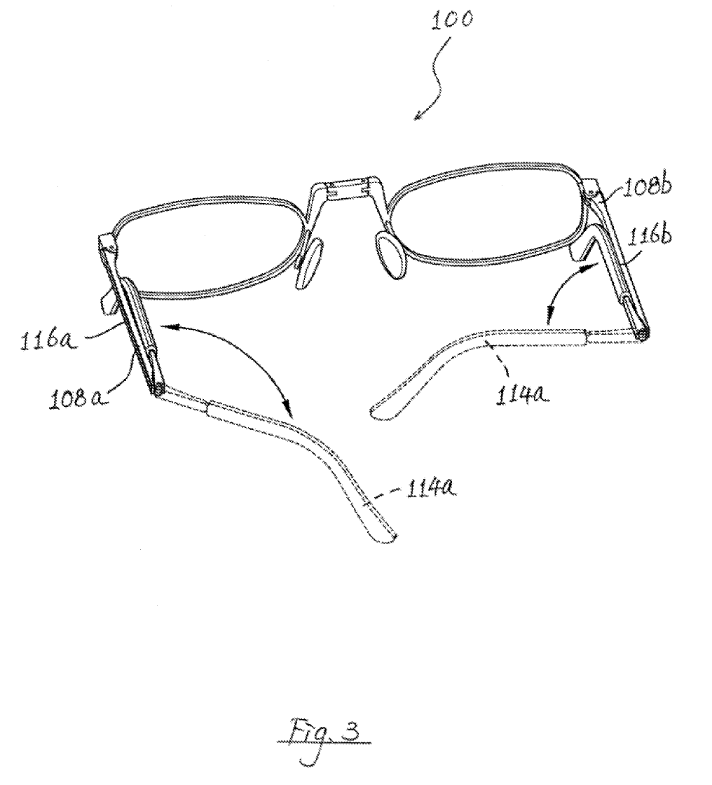

As shown in FIG. 3, each of the arms 108a, 108b includes two pivotable sections, allowing each respective outer section 114a, 114b of the arms 108a, 108b to pivot between the position shown in dotted lines and the position shown in solid line, to allow the outer sections 114a, 114b to bear on a respective inner section 116a, 116b of the arms 108a, 108b.

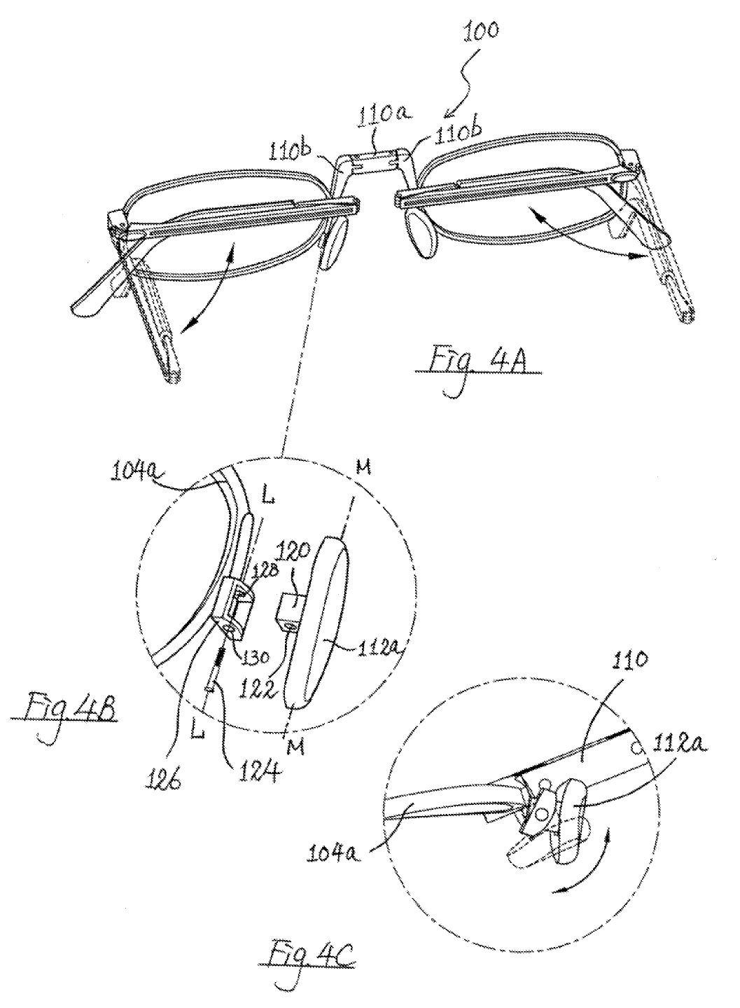

As shown further in FIG. 4A, the arms 108a, 108b may be further folded to the configuration as shown in solid lines by pivoting the inner sections 116a, 116b onto the mounting frames 104a, 104b.

Turning now to FIGS. 4B and 4C, it can be seen that the nose pad 112a is releasably engaged with the inner side of the mounting frame 104a. In particular, the nose pad 112a has a protrusion 120 with a through-hole 122. The through-hole 122 may be or may not be threaded. In any event, the through-hole 122 is sized to allow insertion of a screw 124. There is fixedly mounted to the mounting frame 104a a socket 126 with a space allowing insertion of the protrusion 120 of the nose pad 112a, such that the through-hole 122 of the protrusion 120 of the nose pad 112a aligns with two holes 128, 130 of the socket 126. By way of such an arrangement, the screw 124 may be received through the holes 128, 130 and through-hole 122 to releasably engage the nose pad 112a with the mounting frame 104a, which allows the nose pad 112a to swivel relative to the mounting frame 104a about an axis L-L which lies on a plane containing the mounting frame 104a. It can be seen that the axis L-L is parallel to the longitudinal axis of the screw 124 and a longitudinal axis M-M of the nose pad 112a.

In particular, and as shown in FIG. 4C, by way of the present arrangement, the nose pad 112a is swivellable relative to the mounting frame 104a between a position shown in solid line and a position shown in dotted line. When the nose pad 112a is in the position shown in dotted line, its major surface is generally parallel to the plane containing the mounting frame 104a.

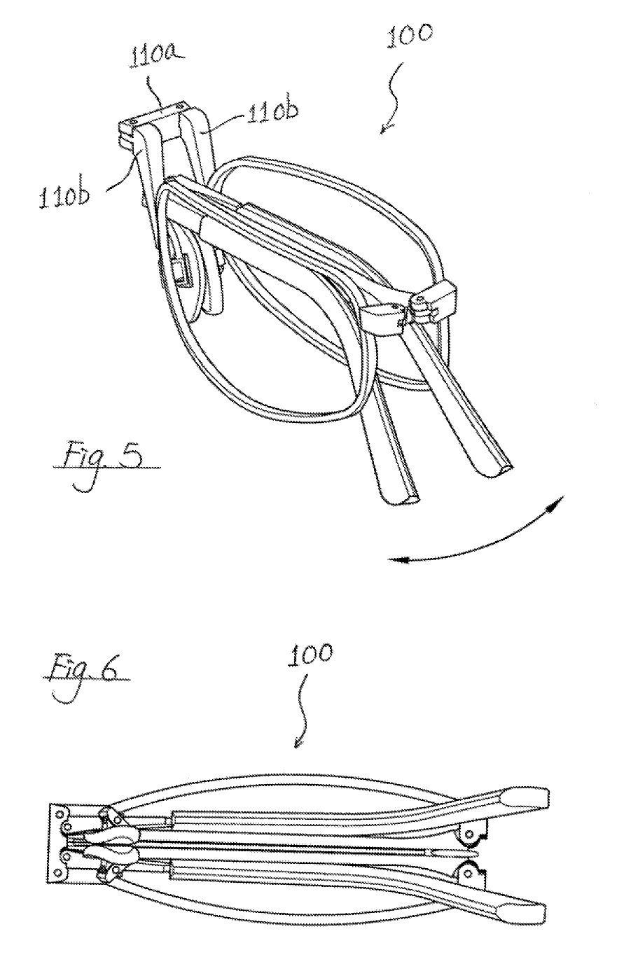

The pair of spectacles 100 may be folded up to the compact configuration as shown in FIGS. 5 and 6, by folding of a pair of legs 110b relative to a connector 10a of the bridge 110. It can be seen in particular that when the pair of spectacles 100 is in the folded-up configuration as shown in FIG. 6, the nose pads 112a, 112b may be swivelled so that their respective free major surfaces are in abutment with each other, thus allowing the pair of spectacles 100 to assume the closely folded up configuration as shown in FIGS. 5 and 6.

In addition, the manner of engagement between the nose pads 112a, 112b with the respective mounting frame 104a, 104b also allows easy self-adjustment of the position of the nose pads 112a, 112b, according to the shape of the nose of the wearer, without much intervention from the wearer.

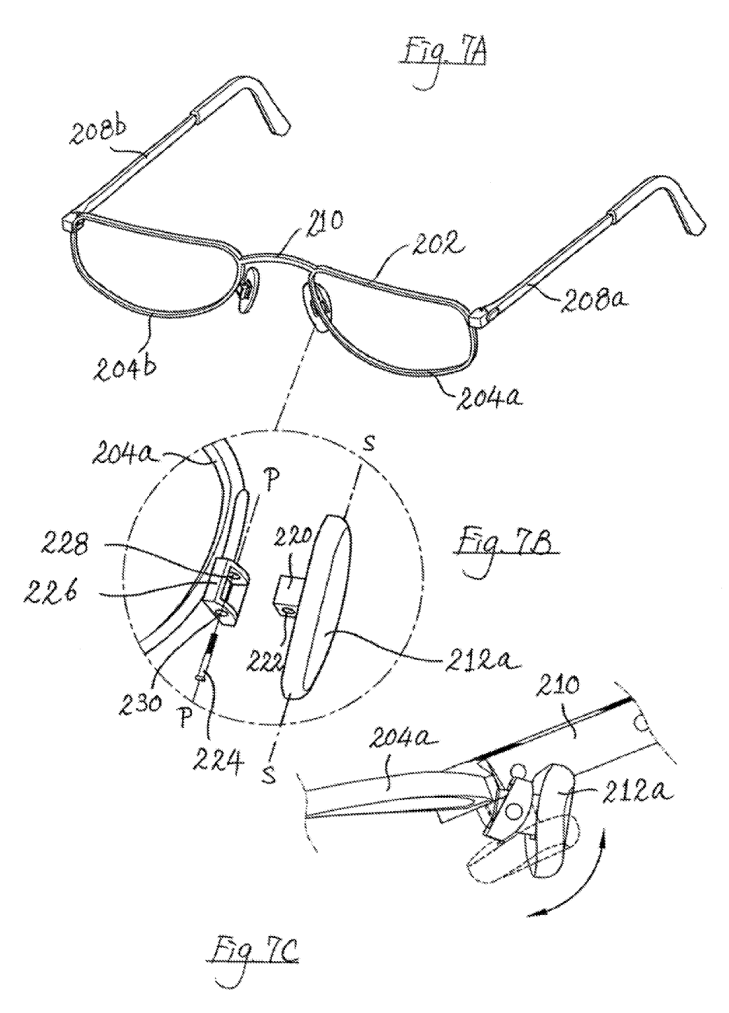

FIG. 7A shows a pair of spectacles according to a second preferred embodiment of the present invention, generally designated as 200. The pair of spectacles 200 differs from the pair of spectacles 100 discussed above in that none of the two arms 208a, 208b and a bridge 210 of the spectacles 200 can be folded onto itself.

As shown in FIGS. 7B and 7C, a nose pad 212a is releasably engaged with the inner side of a mounting frame 204a of a spectacle frame 202. The nose pad 212a has a protrusion 220 with a through-hole 222. The through-hole 222 may be or may not be threaded. In any event, the through-hole 222 is sized to allow insertion of a screw 224. There is fixedly mounted to the mounting frame 204a a socket 226 with a space allowing insertion of the protrusion 220 of the nose pad 212a, such that the through-hole 222 of the protrusion 220 of the nose pad 212a aligns with two holes 228, 230 of the socket 226. By way of such an arrangement, the screw 224 may be received through the holes 228, 230 of the socket 226 and the through-hole 222 of the protrusion 220 to releasably engage the nose pad 212a with the mounting frame 204a, which allows the nose pad 212a to swivel relative to the mounting frame 204a about an axis P-P which lies on a plane containing the mounting frame 204a. It can be seen that the axis P-P is parallel to a longitudinal axis of the screw 224 and a longitudinal axis S-S of the nose pad 212a.

As shown in FIG. 4C, by way of the present arrangement, the nose pad 212a is swivellable relative to the mounting frame 204a between a position shown in solid line and a position shown in dotted line. When the nose pad 212a is in the position shown in dotted line, its major surface is generally parallel to the plane containing the mounting frame 204a.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A spectacle frame including:
a pair of frame members each adapted to releasably hold a piece of optical lens, and
a nose pad engaged with each respective frame member, wherein said nose pad is swivellable about said respective frame member about a respective axis which lies generally on a plane containing said respective frame member.

2. A spectacle frame according to claim 1 wherein each said nose pad is respectively swivellable to a position wherein a major surface of said nose pad is generally parallel to the plane containing said respective frame member.

3. A spectacle frame according to claim 1 wherein said axis is generally parallel to a longitudinal axis of said respective nose pad.

4. A spectacle frame according to claim 1 wherein each said nose pad is engaged with said respective frame member via an engagement member which is substantially parallel to said respective axis of swivelling.

5. A spectacle frame according to claim 4 wherein said engagement member is a screw.

6. A pair of spectacles including a spectacle frame, said spectacle frame including:
a pair of frame members each releasably holding a piece of optical lens, and
a nose pad engaged with each respective frame member, wherein said nose pad is swivellable about said respective frame member about a respective axis which lies generally on a plane containing said respective frame member.

7. A pair of spectacles according to claim 6 wherein each said nose pad is respectively swivellable to a position wherein a major surface of said nose pad is generally parallel to the plane containing said respective frame member.

8. A pair of spectacles according to claim 6 wherein said axis is generally parallel to a longitudinal axis of said respective nose pad.

9. A pair of spectacles according to claim 6 wherein each said nose pad is engaged with said respective frame member via an engagement member which is substantially parallel to said respective axis of swivelling.

10. A pair of spectacles according to claim 9 wherein said engagement member is a screw.
